(19) United States
(12) Patent Application Publication
(10) Pub. No.: US 2026/0300769 A1
(43) Pub. Date: Oct. 1, 2026

(54) METHOD AND DEVICE FOR ENVIRONMENTAL DATA PREDICTION, AND ENVIRONMENTAL DATA PREDICTION SYSTEM

(71) Applicant: ELECTRONICS AND TELECOMMUNICATIONS RESEARCH INSTITUTE, Daejeon (KR)

(72) Inventors: Hak Jong SHIN, Daejeon (KR); Won Kyu CHOI, Daegu (KR); Jungyu KIM, Daejeon (KR); Hyeon PARK, Daegu (KR); Seng Kyoun JO, Daejeon (KR)

(21) Appl. No.: 19/574,895

(22) Filed: Mar. 23, 2026

(30) Foreign Application Priority Data
Mar. 31, 2025 (KR) 10-2025-0041349

(51) Int. Cl. G06N 5/022

(52) U.S. Cl. CPC G06N 5/022

(57) ABSTRACT

The present disclosure relates to an environmental data prediction technology suitable for improving the prediction performance of a virtual sensor model operated in an indoor environment, wherein the environmental data prediction technology for predicting environmental variables for each location in an indoor space based on sensing data from physical sensors disposed in the indoor space, generating an inference result by comparing virtual sensing data from the prediction with physical sensing data, and correcting the virtual sensing data based on the inference result.

### CROSS-REFERENCE TO RELATED APPLICATION

This application claims the benefit of Korean Patent Application No. 10-2025-0041349, filed on Mar. 31, 2025, in the Korean Intellectual Property Office, the entire disclosure of which is incorporated herein by reference for all purposes.

### TECHNICAL FIELD

The present disclosure relates to an environmental data prediction technology suitable for improving the prediction performance of a virtual sensor model operated in an indoor environment.

### BACKGROUND OF THE INVENTION

In the field of indoor environment management, virtual sensors are gaining attention as a technology for predicting environmental variables at various points while minimizing physical sensors. A virtual sensor operates by estimating environmental variables at a specific point by utilizing a machine learning model trained based on data collected from physical sensors, thereby enabling a reduction in sensor installation and maintenance costs.

However, conventional virtual sensors rely on learned data patterns, which leads to a problem in which prediction accuracy degrades if they fail to appropriately reflect data distribution differences occurring due to environmental changes during operation. In particular, since indoor environments continuously change due to various factors such as structures, HVAC systems, and user activities, there is a high probability that prediction errors will accumulate if a conventional virtual sensor model is used in an environment different from the training data.

To solve this problem, a calibration technology continuously monitoring the performance of a virtual sensor and reducing the prediction error of the virtual sensor by reflecting changes in data occurring in the operating environment in real time is required. Conventional calibration methods typically use a static calibration model or periodically retrain the model, but such methods have limitations making immediate response to environmental changes difficult and real-time calibration impossible.

The background technology of the present disclosure is disclosed in Korean Patent Registration No. 10-2419345 (Registered on Jul. 6, 2022).

### SUMMARY OF THE INVENTION

An embodiment of the present disclosure provides an environmental data prediction technology for predicting environmental variables for each location in an indoor space based on sensing data from physical sensors disposed in the indoor space, generating an inference result by comparing virtual sensing data from the prediction with physical sensing data, and correcting the virtual sensing data based on the inference result.

Specifically, an embodiment of the present disclosure provides an environmental data prediction technology correcting predicted values of a virtual sensor in real time by utilizing an error inference model based on an autoencoder-based reconstruction residual (i.e., a difference between original data and reconstructed data occurring when an autoencoder model reconstructs input data) and a Wasserstein distance (i.e., a distance concept useful for measuring how a data distribution changes over time), in order to maintain the prediction accuracy of an indoor environment-expandable virtual sensor. An Autoencoder refers to a neural network model encoding input data and then decoding the encoded data back to an original form of the input data, and is used to extract important features from the input data and remove unnecessary noise.

In accordance with an aspect of the present disclosure, there is provided an environmental data prediction system comprising: a sensor group including a plurality of physical sensors for sensing environmental data at respective locations in an indoor space and generating sensing data from the sensing; an integrated management device for preprocessing the sensing data; and an environmental data prediction device programmed to generate virtual sensing data by predicting environmental variables the respective locations of the plurality of physical sensors based on the sensing data preprocessed by the integrated management device, infer a prediction error based on a result of comparing the virtual sensing data with the sensing data, generate corrected virtual sensing data reflecting a result of the inferred prediction error, and transmit the corrected virtual sensing data to the integrated management device, wherein the environmental data prediction device is programmed to generate alarm data for outputting a warning message via a user terminal when the result of the inferred prediction error is greater than or equal to a predetermined threshold, and transmit the alarm data to the integrated management device.

In accordance with an aspect of the present disclosure, there is provided an environmental data prediction device, comprising: a communication module for receiving sensing data from a sensor group having sensed environmental data at locations in an indoor space; a memory storing an environmental data prediction program including one or more instructions for generating virtual sensing data and corrected virtual sensing data from the sensing data using a pre-trained artificial neural network model; and a processor that loads the environment data prediction program from the memory and executes the environment data prediction program, wherein the one or more instructions, when executed by the processor, cause the processor to: execute the instructions to generate the virtual sensing data by predicting environmental variables for the respective locations of the sensor group, infer a prediction error based on a result of comparing the virtual sensing data with the sensing data, and generate the corrected virtual sensing data reflecting the result of the inferred prediction error.

The artificial neural network model includes a virtual sensor model and an error inference model, wherein the virtual sensor model is pre-trained to generate the virtual sensing data as a learning result based on the sensing data, and the error inference model is pre-trained to generate a result of the prediction error as a learning result based on a result of comparing the virtual sensing data with the sensing data.

The environmental data prediction device is programmed to apply an analysis of an autoencoder-based reconstruction residual and a Wasserstein distance during a training process to evaluate a prediction reliability of the virtual sensor model.

The artificial neural network model includes a virtual sensor correction module, and the virtual sensor correction module is programmed to input the sensing data into the virtual sensor model and output a result of predicting environmental variables for the respective locations of the sensor group in the sensor group, and input the sensing data and the virtual sensing data into the error inference model and output the corrected virtual sensing data.

The virtual sensor correction module is programmed to infer the prediction error by utilizing the reconstruction residual and the Wasserstein distance, and output the corrected virtual sensing data by correcting a result of inferring the prediction error.

The processor is programmed to analyze a difference between the sensing data and the virtual sensing data, and generate alarm data when the difference exceeds a predetermined threshold.

The virtual sensor correction module comprises: an autoencoder model for generating the reconstruction residual by calculating a difference between the sensing data and the virtual sensing data; and a Wasserstein distance calculation model for calculating the Wasserstein distance by analyzing a time-series distribution of the sensing data and measuring a degree of change in a data distribution over time.

The processor is programmed to evaluate a reliability of the virtual sensing data by calculating the prediction error between the sensing data and the virtual sensing data by combining the reconstruction residual and the Wasserstein distance.

In accordance with an aspect of the present disclosure, there is provided an environmental data prediction method executed in an environmental data prediction device including a pre-trained artificial neural network model, the method comprising: receiving sensing data from a sensor group having sensed environmental data at respective locations in an indoor space; generating virtual sensing data by predicting environmental variables for the respective locations of the sensor group from the sensing data using the artificial neural network model; inferring a prediction error based on a result of comparing the virtual sensing data with the sensing data; and generating corrected virtual sensing data reflecting the result of the inferred the prediction error.

The artificial neural network model includes a virtual sensor model and an error inference model, wherein the virtual sensor model is pre-trained to generate the virtual sensing data as a learning result based on the sensing data, and the error inference model is pre-trained to generate a result of the prediction error as a learning result based on a result of comparing the virtual sensing data with the sensing data.

The virtual sensor model is trained by applying an analysis of an autoencoder-based reconstruction residual and a Wasserstein distance to evaluate a prediction reliability of the virtual sensor model.

The artificial neural network model includes a virtual sensor correction module, and the method comprises inputting, by the virtual sensor correction module, the sensing data into the virtual sensor model and outputting a result of predicting environmental variables for the respective locations of a plurality of physical sensors in the sensor group, and inputting the sensing data and the virtual sensing data into the error inference model and outputting the corrected virtual sensing data.

The environmental data prediction method comprising inferring, by the virtual sensor correction module, the prediction error by utilizing the reconstruction residual and the Wasserstein distance, and outputting the corrected virtual sensing data by correcting a result of inferring the prediction error.

The environmental data prediction method further comprising: analyzing a difference between the sensing data and the virtual sensing data; and generating alarm data when the difference exceeds a predetermined threshold.

The virtual sensor correction module comprises: an autoencoder model for generating the reconstruction residual by calculating a difference between the sensing data and the virtual sensing data; and a Wasserstein distance calculation model for calculating the Wasserstein distance by analyzing a time-series distribution of the sensing data and measuring a degree of change in a data distribution over time.

The environmental data prediction method further comprising: evaluating a reliability of the virtual sensing data by calculating a prediction error between the sensing data and the virtual sensing data by combining the reconstruction residual and the Wasserstein distance.

In accordance with an aspect of the present disclosure, there is provided a computer-readable recording medium storing a computer program, wherein the computer program comprises instructions for causing a processor to perform an environmental data prediction method executed in an environmental data prediction device comprising a pre-trained artificial neural network model, and the method comprises: receiving sensing data from a sensor group having sensed environmental data for each location in an indoor space; generating virtual sensing data by predicting environmental variables for each location of the sensor group from the sensing data using the artificial neural network model; inferring a prediction error based on a result of comparing the virtual sensing data with the sensing data; and generating corrected virtual sensing data reflecting a result of inferring the prediction error.

According to an embodiment of the present disclosure, the prediction accuracy of a virtual sensor model may be maintained by monitoring the prediction performance of an indoor environment-expandable virtual sensor model in real time and applying an error inference model based on an autoencoder-based reconstruction residual and a Wasserstein distance.

Furthermore, according to an embodiment of the present disclosure, a problem of degradation in the prediction accuracy of a virtual sensor model according to environmental changes is solved by the virtual sensor model detecting a difference between data at the time of training and data during operation, and correcting an error in real time.

Furthermore, according to an embodiment of the present disclosure, unlike conventional static correction methods, a dynamic correction function of a virtual sensor model adapting to changes in an indoor environment is provided to improve the reliability of indoor environment monitoring while minimizing the installation of physical sensors.

### BRIEF DESCRIPTION OF THE DRAWINGS

FIG. 1 is an exemplary diagram for explaining a concept of a space-expandable virtual sensor applicable to an embodiment of the present disclosure.

FIG. 2 is a block diagram exemplarily illustrating functions of an environmental data prediction system according to an embodiment of the present disclosure.

FIG. 3 is a block diagram exemplarily illustrating a method for environmental data prediction and performance correction of the environmental data prediction system according to an embodiment of the present disclosure.

FIG. 4 is a block diagram exemplarily illustrating an input/output relationship of an artificial neural network model of an environmental data prediction device included in the environmental data prediction system of FIG. 2 and FIG. 3.

FIG. 5 is a diagram exemplarily illustrating a structure of an autoencoder model within the artificial neural network model of FIG. 4.

FIG. 6 is a diagram exemplarily illustrating an operation of a Wasserstein distance calculation model of the artificial neural network model of FIG. 4.

### DETAILED DESCRIPTION OF THE INVENTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

Hereinafter, embodiments of the present disclosure will be described in detail with reference to the attached drawings.

Hereinafter, an embodiment according to the present disclosure will be described with reference to the accompanying drawings.

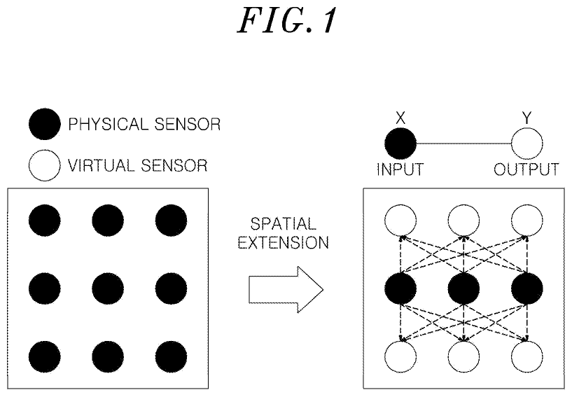

FIG. 1 is an exemplary diagram for explaining a concept of a spatially extended virtual sensor according to an embodiment of the present disclosure, which visually explains the concept of constructing a virtual sensor in an indoor environment by utilizing physical sensors and predicting environmental variables through spatial extension.

In the present embodiment, a virtual sensor performs a role of predicting environmental variables at a specific location based on physical sensor data, and for this purpose, collects data from physical sensors (i.e., actual sensors) disposed in an indoor space.

The physical sensors measure environmental data (i.e., raw data collected from sensors, such as actual collected values like a temperature of 23.5° C., humidity of 60%, and CO₂ of 400 ppm) in real time, and this environmental data is input into a machine learning model to enable the virtual sensor to predict an environmental variable (i.e., an individual component constituting environmental data, such as temperature, humidity, CO₂ concentration, etc.).

The spatial extension of the virtual sensor is performed by estimating environmental data in areas where physical sensors are not disposed, by utilizing a limited number of physical sensors in a given space. To this end, in the present embodiment, physical sensors with high influence on the input data are preferentially selected, and the corresponding data is applied to a virtual sensor model, thereby enabling the prediction of environmental variables at a specific point.

As described above, the present embodiment may generate highly reliable environmental data at various points in an indoor environment while minimizing the number of physical sensors installed. Furthermore, through spatial extension (i.e., a concept of enabling the prediction of environmental data even in areas where sensors are not deployed by utilizing a limited number of physical sensors), the virtual sensor adaptively reflects changes in the indoor environment, thereby enabling the maintenance of real-time prediction performance while complementing the limitations of existing physical sensor networks.

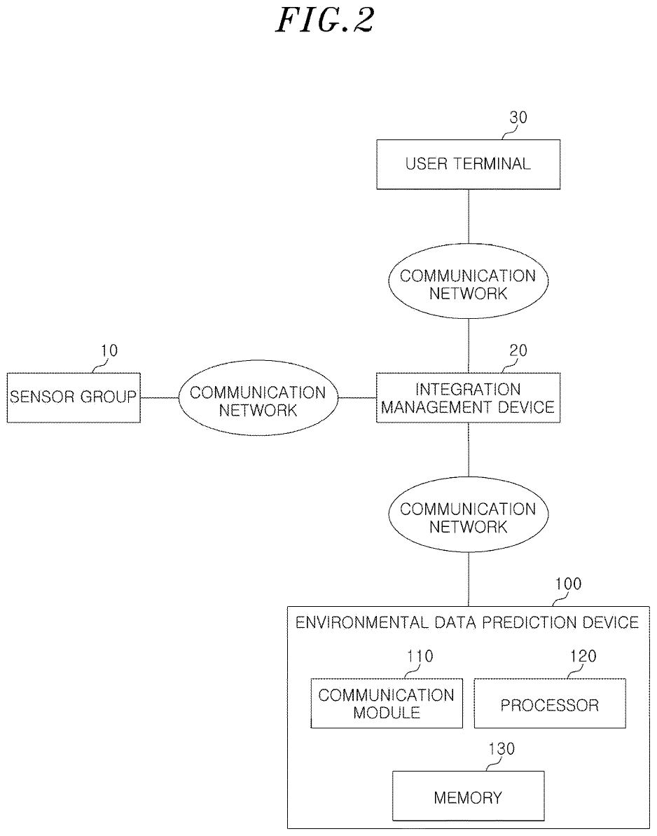

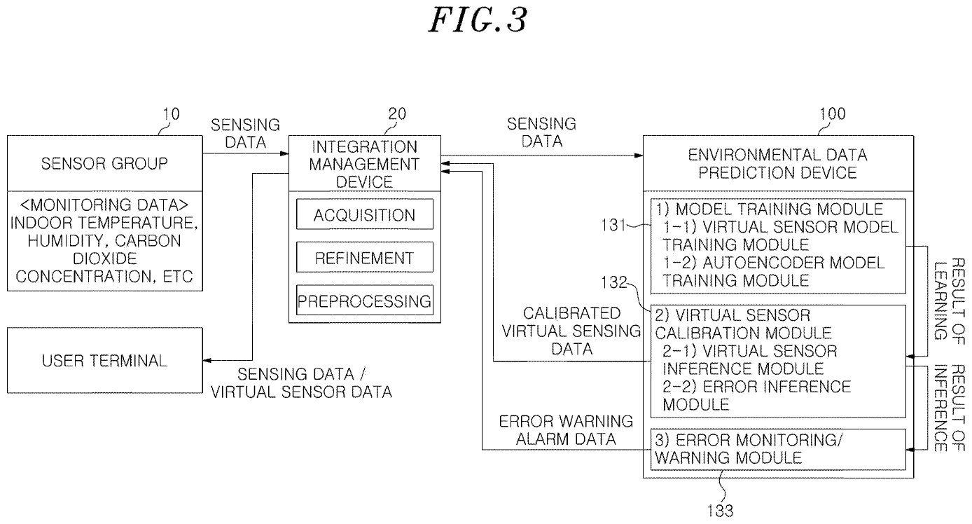

FIG. 2 is a block diagram exemplarily illustrating functions of an environmental data prediction system according to an embodiment of the present disclosure, and FIG. 3 is a block diagram exemplarily illustrating a method for environmental data prediction and performance correction of such an environmental data prediction system.

First, as illustrated in FIG. 2, the environmental data prediction system according to the present embodiment may perform an operation of collecting indoor environmental data from a plurality of physical sensors to generate virtual sensing data predicting environmental variables for each location of the physical sensors, and correcting the performance of the virtual sensing data.

This environmental data prediction system may include a sensor group 10, an integrated management device 20, an environmental data prediction device 100, and a user terminal 30.

The sensor group 10 is a network group implemented as a plurality of physical sensors for sensing various indoor environmental data (e.g., measured values such as temperature, humidity, etc.).

Each physical sensor may be disposed at various points in an indoor space to sense environmental data in real time and generate sensing data from the sensing. The generated sensing data may be transmitted to the integrated management device 20 through a communication network.

Each physical sensor performs a real-time data transmission function, and measured values may be updated at each preset period.

The integrated management device 20 may manage a real-time data flow and perform roles of storing, preprocessing, integrating, and analyzing the sensing data received from the sensor group 10.

The integrated management device 20 stores and preprocesses the sensing data received from the sensor group 10, performs missing value imputation and outlier detection processes to maintain data quality, reviews the continuity and consistency of the sensing data to ensure the prediction accuracy of a virtual sensor, and may apply a correction algorithm as needed.

At this time, the preprocessed sensing data may be transmitted to the environmental data prediction device 100.

The environmental data prediction device 100 may generate virtual sensing data predicting environmental variables for each location based on the preprocessed sensing data transmitted from the integrated management device 20, and correct the predicted values of the generated virtual sensing data in real time.

This environmental data prediction device 100 may include a communication module 110, a processor 120, and a memory 130.

The communication module 110 may receive sensing data from the sensor group 10, which has sensed environmental data for each location in the indoor space.

The processor 120, by executing instructions in the memory 130, may generate virtual sensing data predicting environmental variables for each location of the sensor group 10, infer a prediction error based on a result of comparing the generated virtual sensing data with the sensing data from the sensor group 10, and generate corrected virtual sensing data reflecting the result of inferring the prediction error.

The memory 130 may include instructions for generating virtual sensing data and corrected virtual sensing data from the sensing data from the sensor group 10, using a pre-trained artificial neural network model.

The environmental data prediction device 100 illustrated in FIG. 3 exemplifies detailed functions implemented by the processor 120 of FIG. 2 executing instructions in the memory 130, and may include a model training module 131, a virtual sensor correction module 132, and an error monitoring and warning module 133.

The model training module 131 may include a virtual sensor model training module for training a virtual sensor model based on physical sensing data, and an autoencoder model training module for training an error inference model to infer a prediction error.

The model training module 131 may retrain an existing model (i.e., the virtual sensor model) to adapt to new environmental changes, and update the model or update weights as needed.

The model training module 131 may evaluate the prediction reliability of the virtual sensor model through autoencoder-based reconstruction residual and Wasserstein distance analysis during a training process.

Here, an Autoencoder refers to a neural network model encoding input data and then decoding the encoded data back to an original form of the input data, and is used to extract important features from the input data and remove unnecessary noise. An autoencoder-based reconstruction residual refers to a difference (error) between original data and reconstructed data occurring when the autoencoder model reconstructs the input data. A Wasserstein distance refers to a distance concept useful for measuring how a data distribution changes over time.

The virtual sensor correction module 132 may include a virtual sensor inference module for outputting virtual sensing data (a result of predicting environmental variables for each location of the physical sensors) using the virtual sensor model trained through the model training module 131, and an error inference module for outputting corrected virtual sensing data using the error inference model trained through the model training module 131. That is, the virtual sensor correction module 132 performs a function of calculating predicted values of a virtual sensor based on indoor environmental data and correcting prediction accuracy in real time.

Here, the virtual sensor inference module receives physical sensing data as input and predicts environmental variables at a specific point, and the error inference module estimates a prediction error by utilizing an autoencoder reconstruction residual and a Wasserstein distance, and reflects this in a corrected predicted value. The corrected predicted value may be transmitted to the integrated management device 20 and stored, or may be transmitted to the user terminal 30 or an external system.

The error monitoring and warning module 133, when an error exceeding a threshold occurs in a calculation result of the error inference module, immediately generates a warning notification, enabling an administrator to respond promptly.

The error monitoring and warning module 133 outputs a warning message so that an administrator may recognize that sensor prediction performance has degraded due to changes in the indoor environment, and when necessary (e.g., when the indoor environment changes), may trigger retraining of the virtual sensor model to update the virtual sensor model in real time.

At this time, the warning message may be output through the user terminal 30.

To summarize, the sensor group 10 measures environmental data such as temperature, humidity, etc., in real time and transmits the measured environmental data to the integrated management device 20, and the integrated management device 20 stores and preprocesses the collected data and then transmits the preprocessed data to the environmental data prediction device 100.

The model training module 131 in the environmental data prediction device 100 performs an update when necessary (e.g., when the indoor environment changes) by retraining the virtual sensor model to adapt to new environmental changes.

The virtual sensor correction module 132 generates predicted values of the virtual sensor model and corrects a prediction result through error inference.

A final corrected predicted result value is stored in the integrated management device 20, and may be provided to the user terminal 30 or an external system.

The error monitoring and warning module 133 analyzes a difference between a predicted value and actual sensor data, and generates a warning when the error exceeds an allowable threshold.

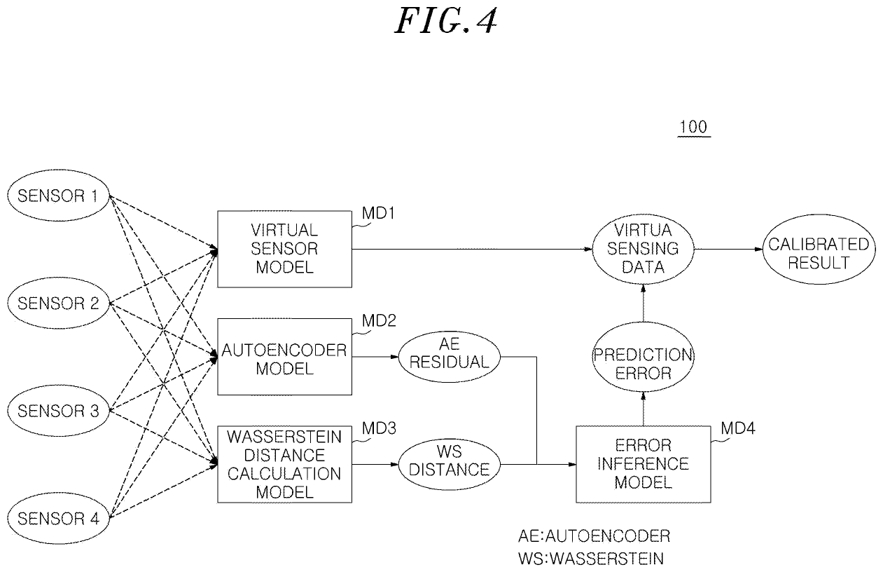

FIG. 4 is a block diagram exemplarily illustrating an input/output relationship of an artificial neural network model of an environmental data prediction device included in the environmental data prediction system of FIG. 2 and FIG. 3.

Referring to FIG. 4, a process of predicting an environmental variable at a specific point through a virtual sensor model by receiving data collected from a plurality of physical sensors (Sensors 1-4) as input, and calibrating this by utilizing an error inference model is visually illustrated.

The present embodiment may include a virtual sensor model MD1, an Autoencoder (AE) model MD2, a Wasserstein (WS) distance calculation model MD3, and an error inference model MD4, and describes a main operational flow for more precisely calibrating the environmental variable predicted value of the virtual sensor.

The physical sensors Sensors 1-4 measure indoor environmental data in real time, and the collected data is input to the virtual sensor model MD1 and, for error analysis, to the Autoencoder model MD2 and the Wasserstein distance calculation model MD3.

The virtual sensor model MD1 predicts environmental variables at a specific point by using the input physical sensor data.

Furthermore, the collected physical sensor data is also input to the Autoencoder model MD2 and the Wasserstein distance calculation model MD3 which perform error analysis, and is used to evaluate the reliability of the predicted value (i.e., environmental variable predicted value).

First, the Autoencoder (AE) model MD2 performs a reconstruction process based on the input physical sensor data and generates a reconstruction residual (AE residual) by calculating the difference between the original data and the reconstructed data.

In one embodiment, the reconstruction residual is utilized for anomaly detection of sensor data and analysis of prediction error, and if a pattern not learned by the virtual sensor model is included, the reconstruction residual may appear large.

This reconstruction residual is then input to the error inference model MD4.

The Wasserstein distance calculation model MD3 analyzes the time-series distribution of the collected sensor data and measures the degree of data distribution change over time.

At this time, the distance indicates how different the data distribution is from the previously learned distribution, and the Wasserstein distance increases if a rapid change occurs during a specific period.

Furthermore, the calculated Wasserstein distance (WS distance) value is input to the error inference model MD4.

The error inference model MD4 combines the Autoencoder reconstruction residual (AE residual) and the Wasserstein distance (WS distance) to calculate the prediction error between the predicted value of the virtual sensor model MD1 and the actual environmental data.

The error inference model MD4 evaluates whether the value predicted in real time is reliable and performs an additional calibration operation when necessary.

In one embodiment, if the prediction error exceeds a threshold, the error inference model MD4 detects this and calibrates the prediction result of the virtual sensor, and finally outputs the calibrated result.

The initial environmental variable predicted by the virtual sensor model MD1 undergoes a verification and calibration process by the error inference model MD4 and is then output as a final calibrated result.

The calibrated result may be provided to the integration management device 20, or may be transmitted to the user terminal 30 or an external device.

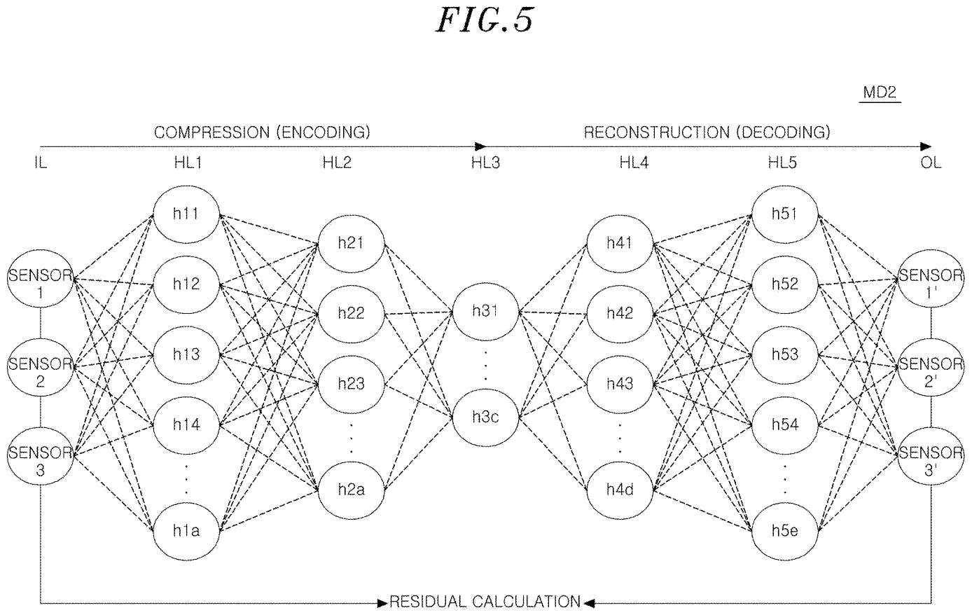

FIG. 5 is an exemplary diagram for schematically explaining a structure of an Autoencoder model MD2 in FIG. 4, visually illustrating the principle of learning the normal pattern of data through a process of compressing (encoding) input sensor data into a low-dimensional feature space and then restoring (decoding) it back to the original data dimension.

The Autoencoder model MD2 is composed of an input layer IL, encoding hidden layers HL1-HL3, decoding hidden layers HL4-HL5, and an output layer OL, and each layer performs a function of extracting and transforming features of the input data.

The Autoencoder model MD2 learns a normal data pattern through unsupervised learning and performs a role of determining whether there is an anomaly in the data by analyzing the difference (reconstruction residual) between the reconstructed data and the original data.

The input layer IL performs a role of receiving indoor environmental data (e.g., temperature, humidity, carbon dioxide concentration, etc.) collected from the physical sensor network 110.

The input data is real-time data measured from various physical sensors Sensors 1-3, transformed into input values for the neural network and transmitted to the next stage.

The encoding hidden layers HL1-HL3 perform a role of progressively compressing the input data into a low-dimensional space.

The neurons h11, h12, . . . , h3c of each encoding hidden layer HL1-HL3 learn the features of the input data, and a process of extracting more important features is performed as the data passes through the layers.

The final encoding hidden layer HL3 includes the latent representation of the data, and this value becomes a core representation space of the Autoencoder model MD2. In this process, it performs a function of learning a normal data pattern and compressing and representing the main patterns of the sensor data.

The decoding hidden layers HL4-HL5 perform a role of reconstructing the encoded data back to the original input data dimension.

In this process, the decoding hidden layer operates by predicting the original data based on the features of the compressed data and is designed to reconstruct the input data while maintaining the learned normal pattern.

The neurons h41, h42, . . . , h5e of each decoding hidden layer HL4-HL5 are responsible for a function of reconstructing the original features of the input data, and the final decoding hidden layer HL5 generates data to be transmitted to the output layer OL.

The output layer OL outputs data of the same dimension as the original data, and this becomes a criterion for evaluating whether the input data maintains a normal pattern.

The reconstructed data Sensor 1′, Sensor 2′, Sensor 3′ output from the output layer OL is compared with the original data Sensor 1, Sensor 2, Sensor 3 of the input layer IL to calculate a reconstruction error (i.e., a reconstruction residual).

If the reconstruction residual is small, the input data is determined to be similar to a normal data pattern, and if the reconstruction residual is large, it is determined that there is a high probability that the input data is abnormal data (e.g., sensor error, environmental change, etc.).

The Autoencoder model MD2 learns a normal sensor data pattern and performs a role of detecting whether the predicted data deviates from the normal range.

In one embodiment, if the reconstruction residual is smaller than a specified standard, it may be determined that the prediction result of the virtual sensor is reliable because a normal data pattern is being maintained. If the reconstruction residual is larger than the specified standard, the input data deviates from a previously learned normal data pattern, so there is a possibility that the prediction accuracy of the virtual sensor may decrease. If the reconstruction residual exceeds a threshold, it may be determined that a calibration of the virtual sensor is necessary due to a high probability of an environmental change or an anomaly in the sensor measurement.

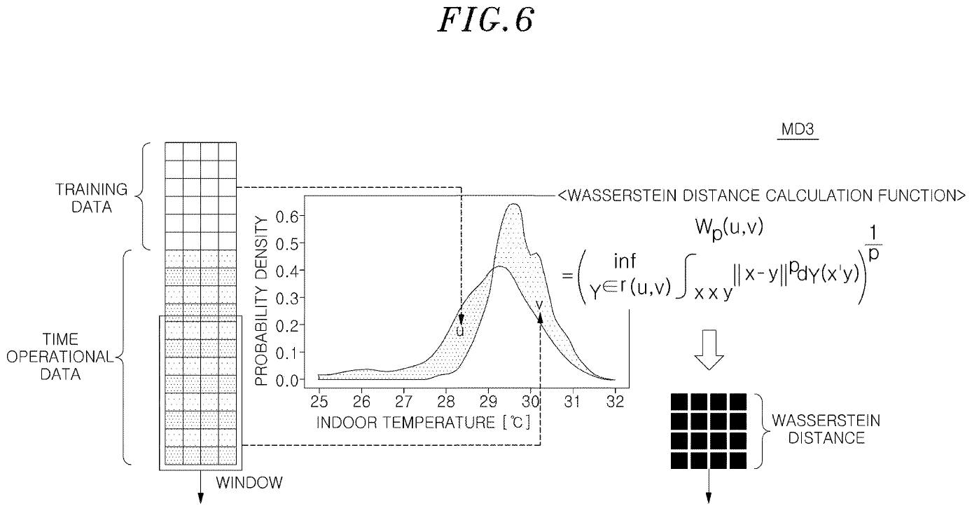

FIG. 6 is an exemplary diagram for schematically explaining an operation of a Wasserstein distance calculation model in FIG. 4, which visually illustrates a process of analyzing a difference between a learned training data distribution and a real-time operational data distribution through Wasserstein distance calculation.

The Wasserstein distance is used to measure how a data distribution changes over time by analyzing indoor environmental data in a time-series manner, and in the present embodiment, it is utilized as an important indicator for detecting a decrease in the prediction performance of the virtual sensor in the error inference module 2-2 of the virtual sensor calibration module 132.

The Wasserstein distance calculation model MD3 calculates a Wasserstein distance by comparing the distribution of learned sensor data (i.e., training data) with the distribution of sensor data operating in real time (i.e., real-time operational data), and provides this as an input to the error inference model.

The training data refers to the distribution of normal sensor data on which the virtual sensor model MD1 was previously trained, and it includes past measurements of indoor temperature, humidity, and carbon dioxide concentration.

The real-time operational data is the environmental data currently being measured by the physical sensor network 110 and reflects the continuously changing indoor environment information.

The two data sets (i.e., training data, real-time operational data) are stored in a time-series manner, which enables the analysis of data changes over time.

For the analysis of real-time operational data, the Wasserstein distance calculation model MD3 applies a sliding window method to select data from a specific time interval. The sliding window defines data collected over a certain past period as a fixed-size block (Window) and is periodically updated to reflect the latest data.

This sliding window method enables an immediate response to environmental changes and allows for a more precise analysis of the distribution changes in real-time data.

The Wasserstein distance calculation model MD3 calculates the difference between the real-time operational data distribution ν selected through the sliding window and the training data distribution as the Wasserstein distance Wp(μ, ν).

In one embodiment, the Wasserstein distance calculation is defined as in the following Equation 1.

$${W}_{p} ( μ , ν ) = {{inf}_{γ ∈ Γ ( μ , ν )} ( {\int }_{X \times Y} {‖ x - y ‖}^{p} d γ ( x , y ) )}^{\frac{1}{p}} \qquad Equation 1$$

where,
μ: probability distribution of training data
ν: probability distribution of real-time operational data
Γ(μ, ν): set of all possibilities connecting the two distributions
∥x− [symbol] ∥: Euclidean distance between data

The Wasserstein distance is an indicator quantitatively measuring how much two data distributions differ, and a larger value means that the indoor environmental data is changing differently from the previously learned data pattern. Conversely, if the Wasserstein distance is small, it means that the current real-time data maintains a distribution similar to the training data.

In the present embodiment, the calculated Wasserstein distance value is input to the error inference model MD4 along with the Autoencoder reconstruction residual to estimate the prediction error of the virtual sensor.

The Autoencoder reconstruction residual (AE residual) focuses on determining whether individual data points are anomalous, whereas the Wasserstein distance focuses on evaluating whether the entire data distribution maintains a normal pattern.

In one embodiment, if the Wasserstein distance increases beyond a threshold, this indicates that the indoor environment is changing differently from the training data, so there is a high probability that the virtual sensor model MD1 is not operating normally.

Based on this, the error inference model MD4 calibrates the predicted virtual sensor value in real time and may retrain the virtual sensor model when necessary.

The sensor group 10 measures environmental data such as indoor temperature, humidity, and carbon dioxide concentration in real time and transmits it to the integration and management device 20.

Each physical sensor constituting the sensor group 10 may measure data according to a designated sampling period and transmits the data to the integration management device 20 through a network (i.e., a communication network).

The integration management device 20 obtains, refines, and preprocesses the environmental data collected from the sensor group 10, and transmits it to the environmental data prediction device 100.

A data acquisition module within the integration management device 20 receives and collects the data transmitted from the sensor group 10.

A data refinement module within the integration management device 20 detects and corrects outliers and missing values in the collected data.

A data preprocessing module within the integration management device 20 normalizes the data, transforms it into a form suitable for analysis, and transmits it to the environmental data prediction device 100.

The data preprocessed in the integration management device 20 may include physical sensor data and existing virtual sensor calibration data, which plays an important role in maintaining the prediction performance of the virtual sensor.

The environmental data prediction device 100 is a processing device (i.e., a processor) performing virtual sensor prediction (i.e., environmental variable prediction), calibration, training, and error monitoring.

A virtual sensor model training module 1-1 within the model training module 131 trains a virtual sensor model based on the physical sensor data.

An Autoencoder model training module 1-2 within the model training module 131 trains an Autoencoder model to minimize the prediction error of the existing virtual sensor and performs a role of optimizing the reconstruction performance of the model.

The model training module 131 retrains the virtual sensor model when a new environmental change is detected to maintain performance.

A virtual sensor inference module 2-1 within the virtual sensor calibration module 132 performs a function of predicting environmental variables at a specific point by receiving physical sensor data as input.

An error inference module 2-2 within the virtual sensor calibration module 132 performs an analysis based on the Autoencoder reconstruction residual and the Wasserstein distance, and plays a role in calculating the prediction error of the virtual sensor.

The virtual sensor calibration module 132 calibrates the virtual sensor data predicted in real time to generate more reliable data.

The error monitoring and warning module 133 immediately generates a warning message if the prediction error calculated in the error inference module 2-2 within the virtual sensor calibration module 132 exceeds a threshold.

The error monitoring/warning module 133 transmits warning data to a system log or the user terminal 30 to enable a manager to recognize in real time the fact that the sensor prediction performance has degraded due to an indoor environmental change. Furthermore, it may retrain the virtual sensor model in conjunction with the model training module 131 when necessary.

As described above, in the apparatus for performance calibration of an indoor environment virtual sensor according to the present embodiment, the sensor group 10 measures indoor environmental data and transmits it to the integration management device 20.

The integration management device 20 obtains, refines, and preprocesses the collected data, and then transmits it to the environmental data prediction device 100.

The environmental data prediction device 100 trains a virtual sensor model through the model training module 131 and performs real-time calibration through the virtual sensor calibration module 132.

The error inference module 2-2 within the virtual sensor calibration module 132 calculates an error by comparing the predicted value with the actual physical sensor data and generates calibrated virtual sensor data. The calibrated virtual sensor data is transmitted to the user terminal 30 and is provided to enable real-time monitoring of the indoor environment.

The error monitoring and warning module 133 generates a warning message if the prediction error is above a threshold and transmits (outputs) it to the user terminal 30 or a manager through the integration management device 20.

Furthermore, the model training module 131 may retrain the virtual sensor model when necessary (i.e., according to specified conditions) to adjust it to adapt to environmental changes.

As described above, according to an embodiment of the present disclosure, a virtual sensor model is operated based on physical sensor data, and prediction accuracy is maintained by correcting predicted environmental variables in real time. For this, an error inference model based on an autoencoder reconstruction residual and a Wasserstein distance is applied to detect changes in data distribution and minimize prediction errors.

Furthermore, according to an embodiment of the present disclosure, reliable environmental data is provided by detecting performance degradation of a virtual sensor in real time and immediately correcting it. Through this, precise environmental prediction over a wide range is enabled while minimizing the installation of physical sensors, and the efficiency of indoor environment monitoring may be maximized.

Furthermore, according to an embodiment of the present disclosure, a problem of degradation in the prediction accuracy of a virtual sensor according to environmental changes may be solved by the virtual sensor model detecting a difference between data at the time of training and data during operation, and correcting an error in real time.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. An environmental data prediction system comprising:
a sensor group including a plurality of physical sensors for sensing environmental data at respective locations in an indoor space and generating sensing data from the sensing;
an integrated management device for preprocessing the sensing data; and
an environmental data prediction device programmed to generate virtual sensing data by predicting environmental variables the respective locations of the plurality of physical sensors based on the sensing data preprocessed by the integrated management device, infer a prediction error based on a result of comparing the virtual sensing data with the sensing data, generate corrected virtual sensing data reflecting a result of the inferred prediction error, and transmit the corrected virtual sensing data to the integrated management device,
wherein the environmental data prediction device is programmed to generate alarm data for outputting a warning message via a user terminal when the result of the inferred prediction error is greater than or equal to a predetermined threshold, and transmit the alarm data to the integrated management device.

2. An environmental data prediction device, comprising:
a communication module for receiving sensing data from a sensor group having sensed environmental data at locations in an indoor space;
a memory storing an environmental data prediction program including one or more instructions for generating virtual sensing data and corrected virtual sensing data from the sensing data using a pre-trained artificial neural network model; and
a processor that loads the environment data prediction program from the memory and executes the environment data prediction program,
wherein the one or more instructions, when executed by the processor, cause the processor to:
execute the instructions to generate the virtual sensing data by predicting environmental variables for the respective locations of the sensor group,
infer a prediction error based on a result of comparing the virtual sensing data with the sensing data, and
generate the corrected virtual sensing data reflecting the result of the inferred prediction error.

3. The environmental data prediction device of claim 2,
wherein the artificial neural network model includes a virtual sensor model and an error inference model,
wherein the virtual sensor model is pre-trained to generate the virtual sensing data as a learning result based on the sensing data, and the error inference model is pre-trained to generate a result of the prediction error as a learning result based on a result of comparing the virtual sensing data with the sensing data.

4. The environmental data prediction device of claim 3,
wherein the environmental data prediction device is programmed to apply an analysis of an autoencoder-based reconstruction residual and a Wasserstein distance during a training process to evaluate a prediction reliability of the virtual sensor model.

5. The environmental data prediction device of claim 3,
wherein the artificial neural network model includes a virtual sensor correction module, and the virtual sensor correction module is programmed to input the sensing data into the virtual sensor model and output a result of predicting environmental variables for the respective locations of the sensor group in the sensor group, and input the sensing data and the virtual sensing data into the error inference model and output the corrected virtual sensing data.

6. The environmental data prediction device of claim 5,
wherein the virtual sensor correction module is programmed to infer the prediction error by utilizing the reconstruction residual and the Wasserstein distance, and output the corrected virtual sensing data by correcting a result of inferring the prediction error.

7. The environmental data prediction device of claim 2,
wherein the processor is programmed to analyze a difference between the sensing data and the virtual sensing data, and generate alarm data when the difference exceeds a predetermined threshold.

8. The environmental data prediction device of claim 6,
wherein the virtual sensor correction module comprises:
an autoencoder model for generating the reconstruction residual by calculating a difference between the sensing data and the virtual sensing data; and
a Wasserstein distance calculation model for calculating the Wasserstein distance by analyzing a time-series distribution of the sensing data and measuring a degree of change in a data distribution over time.

9. The environmental data prediction device of claim 8,
wherein the processor is programmed to evaluate a reliability of the virtual sensing data by calculating the prediction error between the sensing data and the virtual sensing data by combining the reconstruction residual and the Wasserstein distance.

10. An environmental data prediction method executed in an environmental data prediction device including a pre-trained artificial neural network model, the method comprising:
receiving sensing data from a sensor group having sensed environmental data at respective locations in an indoor space;
generating virtual sensing data by predicting environmental variables for the respective locations of the sensor group from the sensing data using the artificial neural network model;
inferring a prediction error based on a result of comparing the virtual sensing data with the sensing data; and
generating corrected virtual sensing data reflecting the result of the inferred the prediction error.

11. The environmental data prediction method of claim 10,
wherein the artificial neural network model includes a virtual sensor model and an error inference model, wherein the virtual sensor model is pre-trained to generate the virtual sensing data as a learning result based on the sensing data, and the error inference model is pre-trained to generate a result of the prediction error as a learning result based on a result of comparing the virtual sensing data with the sensing data.

12. The environmental data prediction method of claim 11,
wherein the virtual sensor model is trained by applying an analysis of an autoencoder-based reconstruction residual and a Wasserstein distance to evaluate a prediction reliability of the virtual sensor model.

13. The environmental data prediction method of claim 11,
wherein the artificial neural network model includes a virtual sensor correction module, and the method comprises inputting, by the virtual sensor correction module, the sensing data into the virtual sensor model and outputting a result of predicting environmental variables for the respective locations of a plurality of physical sensors in the sensor group, and inputting the sensing data and the virtual sensing data into the error inference model and outputting the corrected virtual sensing data.

14. The environmental data prediction method of claim 13,
comprising inferring, by the virtual sensor correction module, the prediction error by utilizing the reconstruction residual and the Wasserstein distance, and outputting the corrected virtual sensing data by correcting a result of inferring the prediction error.

15. The environmental data prediction method of claim 11,
further comprising:
analyzing a difference between the sensing data and the virtual sensing data; and
generating alarm data when the difference exceeds a predetermined threshold.

16. The environmental data prediction method of claim 14,
wherein the virtual sensor correction module comprises:
an autoencoder model for generating the reconstruction residual by calculating a difference between the sensing data and the virtual sensing data; and
a Wasserstein distance calculation model for calculating the Wasserstein distance by analyzing a time-series distribution of the sensing data and measuring a degree of change in a data distribution over time.

17. The environmental data prediction method of claim 16,
further comprising:
evaluating a reliability of the virtual sensing data by calculating a prediction error between the sensing data and the virtual sensing data by combining the reconstruction residual and the Wasserstein distance.
